(19) United States
(12) Patent Application Publication
(10) Pub. No.: US 2012/0116984 A1
(43) Pub. Date: May 10, 2012

(54) AUTOMATED EVALUATION OF COMPLIANCE DATA FROM HETEROGENEOUS IT SYSTEMS

(75) Inventors: Tai Hoang, Newcastle, WA (US); Wayne T. Foley, Seattle, WA (US); Gunjan Jain, Redmond, WA (US)

(73) Assignee: MICROSOFT CORPORATION, Redmond, WA (US)

(21) Appl. No.: 12/942,039

(22) Filed: Nov. 9, 2010

(51) Int. Cl. G06Q 99/00

(52) U.S. Cl. 705/317

(57) ABSTRACT

Compliance-relevant data from external systems comprising managed entities can be received, stored, processed, transformed and evaluated in an automated fashion. Compliance reporting can be generated dynamically to reflect the most current regulations, guidance and system operating conditions. Compliance data from external systems can be converted into a unified format compatible with a compliance management schema. A series of transformations can be applied to the compliance-relevant data. A compliance threshold can be provided to the compliance management system and compliance scoring can be provided.

### BACKGROUND

Governance, risk management and compliance (GRC) typically encompasses activities that include corporate governance, enterprise risk management (ERM) and corporate compliance with applicable laws and regulations. Governance describes the overall management approach through which senior executives direct and control an organization. Governance activities are directed to ensuring that information provided to the executive team is complete, accurate and timely to help management make good decisions, establish appropriate control mechanisms and execute the controls systematically and effectively.

Risk management includes processes by which management identifies, analyzes and responds to risks that affect an organization's business objectives. External legal and regulatory compliance risks are included in these issues.

Compliance encompasses conforming to stated directives. Organizational compliance depends on management processes that identify applicable directives (defined for example in laws, regulations, contracts, strategies and policies), assess the state of compliance, assess the risks and potential costs of non-compliance against the projected expenses to achieve compliance, and prioritize, fund and initiate corrective actions.

### SUMMARY

Compliance-relevant data from external systems can be received, stored, processed, and evaluated in an automated fashion. Compliance reporting can be generated dynamically to reflect the most current regulations, guidance and system operating conditions. Compliance data from external systems is converted into a unified format compatible with a schema, enabling third parties to plug their data into the compliance management system. A series of transformations are applied to the compliance-relevant data. During the transformations the compliance-relevant data is combined with other data that describes the desired information technology controls and compliance programs in a compliance management system. Compliance data is stored in a data store associated with the compliance management server. Compliance data can be evaluated and reports can be generated by the compliance management system to indicate whether or not an organization is meeting expectations for compliance. Compliance scores can be reported using a provided compliance threshold for a compliance program.

An integrated platform for automating and adapting information technology (IT) service management best practices to an organization's needs can be provided. Implementation of control activities can be automated. On-going validation and test of compliance programs can be optimized, so that an organization can be ready for an IT audit at any time. Compliance and risk management can be integrated with a service management software suite that provides built-in processes based on industry best practices for incident and problem resolution, change control, and asset lifecycle management. Multiple compliance programs can be managed and automated. A compliance library can continuously update directives derived from regulatory standards and other authority documents and can harmonize them into a consolidated set of control objectives. A library can be instantiated with recommended control objectives, activities, and settings particular to operating systems and applications. Control activities can be automated. Control activities include a test and evidence process to facilitate continuous audit readiness and cost reduction. Changes to achieve compliance can be facilitated. A predefined management pack that facilitates compliance management can be provided. The predefined compliance management pack can be customized to meet the particular needs of a particular organization. New compliance management packs can be created if needed (e.g., in instances when the majority of features and objects are not defined in a predefined compliance management pack).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1 illustrates an example of a compliance management system 100 in accordance with aspects of the subject matter disclosed herein;

FIG. 2 is an example of a schema 200 for a compliance management system in accordance with aspects of the subject matter disclosed herein;

FIG. 3 is a flow diagram of an example of a method 300 for compliance management in accordance with aspects of the subject matter disclosed herein; and

FIG. 4 is a block diagram of an example of a computing environment in accordance with aspects of the subject matter disclosed herein.

### DETAILED DESCRIPTION

### Overview

A compliance management system can translate auditor expectations into IT tasks through the use of control activities that are particular to a technology or platform. The compliance management system can be integrated with a configuration manager to automate the monitoring, validation, and reporting of the compliance state of products. The compliance management system can map control objectives to system infrastructure. Control activities can connect control objectives to product configuration settings and events. Control activities and test automation can be supplied for products including but not limited to Windows Server® 2008, Windows Server® 2008 R2, Windows 7, and System Center. Product-particular Desired Configuration Management packs can also be included.

In accordance with aspects of the subject matter described herein, data received from one or more external, potentially diverse systems is collected, processed and stored. A connection to each external system can be made and the compliance-relevant data can be transferred to the compliance management system.

Automated Evaluation of Compliance Data from Heterogeneous IT Systems

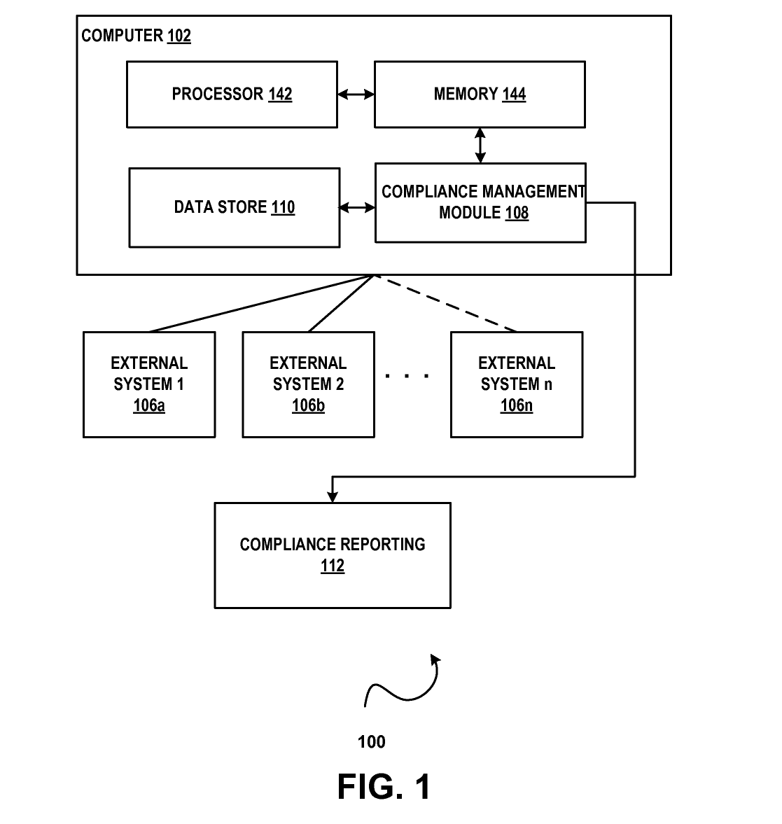

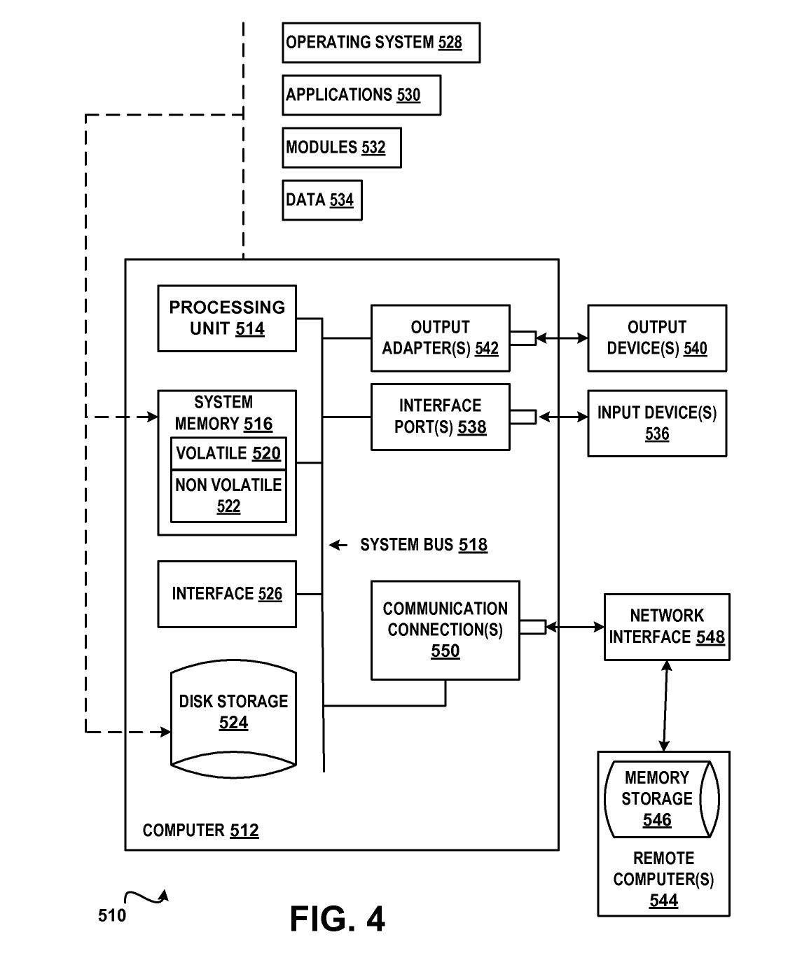

FIG. 1 illustrates an example of a compliance management system 100 in accordance with aspects of the subject matter disclosed herein. All or portions of compliance management system 100 can reside on one or more computers such as computer 102. A computer is described below with respect to FIG. 4. Compliance management system 100 or portions thereof may be provided as a stand-alone system or as a plug-in or add-in. Compliance management system 100 or portions thereof may be provided as a plug-in or add-in to a system management package.

Compliance management system 100 may include one or more of: a computer 102 or computing device (e.g., datacenter computer, desktop computer, etc.) including a processor (such as processor 142), a memory such as memory 144, and one or more compliance management modules represented in FIG. 1 by compliance management module 108. Other components well known in the arts may also be included but are not here shown. It will be appreciated that the compliance management module 108 can be loaded into memory 144 to cause one or more processors such as processor 142 to perform the actions attributed to the compliance management module 108.

In accordance with aspects of the subject matter disclosed herein, one or more compliance management modules of compliance management system 100 can receive compliance-relevant information from one or more external systems, represented in FIG. 1 by external system 1 106a, external system 2 106b . . . external system n 106n. External system 1 106a, external system 2 106b . . . external system n 106n can be the same or similar systems or can be diverse or different systems. External system 1 106a, external system 2 106b . . . external system n 106n can be a computer, an object (e.g., a door, a badge reader, a credit card reader, and so on), a group of people (e.g., users, employees, customers and so on), a product, a device or an organization (e.g., a business, a governmental body, and so on) and so on. An external system can include information for one or more managed entities. Examples of information received from external system 1 106a, external system 2 106b . . . external system n 106n include but are not limited to system settings, registry settings, functions enabled, operating system platform, events, notifications, alerts, and report outputs. Compliance manager modules of compliance management system 100 can provide GRC management for an organization. One or more compliance management modules, represented in FIG. 1 by compliance management module 108, can transform the information received from external system 1 106a, external system 2 106b . . . external system n 106n into a standardized data structure (e.g., a managed entity object) that conforms to a compliance management schema that can be used by one or more modules in the compliance management system 100.

One or more compliance management modules such as compliance management module 108 can perform various compliance management functions as described more fully below. Compliance management module 108 can extract applicable directives derived from GRC authority documents. GRC authority documents can include but are not limited to laws, regulations, contracts, strategies, best practices and policies. The laws, regulations, contracts, strategies, best practices and policies, etc. can be associated with compliance requirements specified in the authority documents including but not limited to HIPAA 5010, HITECH, ICD-10, GLBA-FFIEC, PCI DSS, 201 CMR 17 and so on. Compliance management module 108 can translate auditor expectations and applicable directives derived from one or more GRC authority documents into control objectives (IT tasks) that can be implemented by one or more control activities. That is, the control activities can map complex IT GRC directives, stated as control objectives, to product configuration settings and events. The control activities can be particular to a particular technology or platform (e.g., Windows Server® 2008, 2008 R2, Windows 7, etc.).

Control activities can include policy, technical, and configuration guidance. The compliance management module 108 can assess the state of compliance of a managed entity or group of managed entities by determining a compliance result. Groups of compliance results can be aggregated to compute a compliance score that is a measure of a compliance of an organization with a particular program. A compliance score can be reported, represented in FIG. 1 by compliance reporting 112. Compliance reporting can include a compliance score calculated dynamically using the most current data available in which warehoused data is refreshed with the most current regulations, compliance-related data, control activities and so on. The most current compliance-relevant data can be retrieved by connecting to one or more of the external systems such as external system 1 106a, external system 2 106b . . . external system n 106n. Integration with a system management software suite can enable automation of monitoring, validation, and reporting of compliance state of a product or products. Control activities can link complex IT GRC directives, stated as control objectives, to actual product configuration settings enabling GRC management.

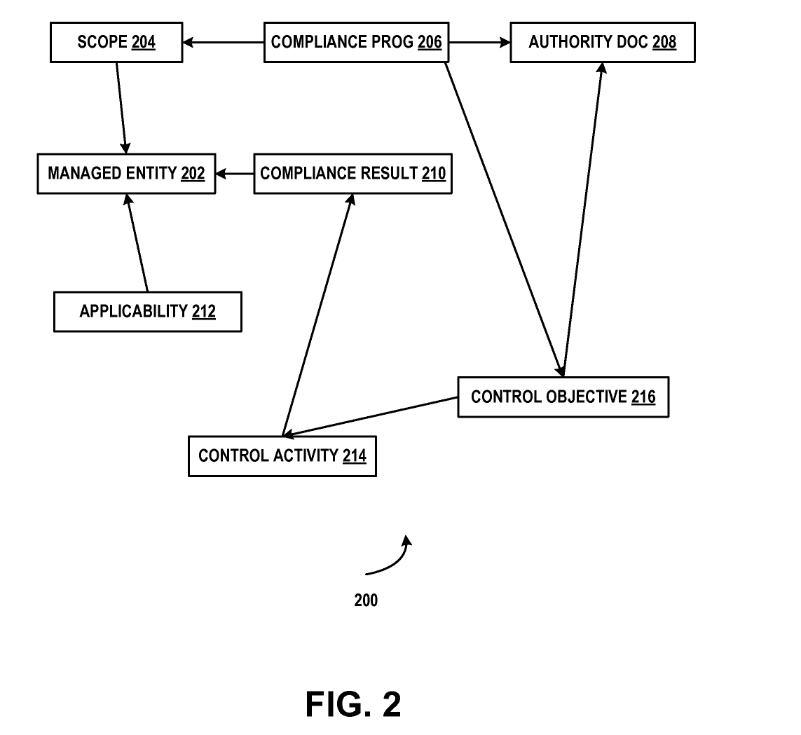

A datastore such as datastore 110 associated with compliance management module 108 can include any combination of, any or all of the following collections of data items: managed entity, scope, compliance program, authority document, compliance result, applicability, control activity, and/or control objective. These data items are described more fully with respect to FIG. 2.

FIG. 2 illustrates an example of a schema 200 that can be used by a compliance management system such as the one described with respect to FIG. 1. Schema 200 in accordance with some aspects of the subject matter disclosed herein can include one or more tables or relational databases comprising information associated with one or more of the following types of data: managed entity 202, scope 204, compliance program 206, authority document 208, compliance result 210, applicability 212, control activity 214 and control objective 216. A managed entity 202 can represent a computer, an object (e.g., a door, a badge reader, a credit card reader, and so on), a group of people (e.g., users, employees, customers and so on), a product, a device or an organization (e.g., a business, a governmental body, and so on) or any other manageable resource. Scope 204 refers to the scope of managed entities to which a compliance program 206 applies. A compliance program 206 refers to a program that is set up to comply with a set of regulations, best practices, policies, etc. that apply to an aspect of a business, organization, or the like. A compliance program can define a collection of risks, control objectives, activities and compliance results. A program can be created to address compliance with one or more authority documents and the risks associated with an IT GRC management program.

Compliance program information stored can include but is not limited to description, justification, scope, status, program settings, threshold, identifier, shared external identifier, external name, external version and so on. The regulations, best practices, policies, etc. may be provided in an authority document 208. Information associated with the authority document 208 can include but is not limited to external identifier, external name, external version, description, type, document category and status. The authority document 208 can be analyzed by the compliance management module to generate one or more control objectives 216 that implement goals derived from or associated with the authority document 208. A control objective can represent a harmonized statement of expectations from GRC authority documents from which directives for the managed entity are derived. A particular control objective can be associated with more than one authority document and can be met by fulfilling one or more control activities. Information associated with a control objective can include identifier, whether or not the control objective is shared by one or more compliance program or authority document, an external name, an external version, an external parent identifier, if the control objective is one of a set of objectives within a more inclusive objective, an external parent category identifier, a type, a level, a status and/or a priority.

The control activity 214 can represent technologically-particular actions performed to accomplish a control objective. A control activity may comprise particular, actionable steps to configure and/or operate the product in accordance with relevant directives within a control objective. A control activity can address more than one control objective and can be manual or automated. Control activity information can include external identifier, external name, external version, type, status, shared indicator, additional guidance, implementation method, gap statement, result, result date, priority, level, test identifier, test name, test summary, test criteria, test gap statement, frequency, and/or start date. The compliance result 210 represents results of checking to see if the control activity 214 was successfully accomplished or not. The compliance result can be a test result of compliance validation that is performed for a managed entity. The tests can be manual or automated tests. The compliance result can include information including but not limited to an identifier, a source test identifier, a source test name, a managed entity identifier, a managed entity type, a last scanned time, details, result, and/or result type. Applicability 212 is a categorization of managed entities for which a particular control activity 214 is applicable.

Each compliance program data element can point to or be associated with multiple scope data elements. Each scope data element can point to or be associated with multiple compliance programs. Each scope data element can point to or be associated with multiple managed entity data elements. Each managed entity can have multiple scope data elements associated with different compliance programs. Each compliance program can point to or be associated with multiple authority documents. Each authority document can point to or be associated with multiple compliance programs. Each authority document can point to or be associated with multiple control objectives. Each control objective can point to or be associated with multiple authority documents and compliance programs. Each compliance program can point to or be associated with multiple control objectives. Each control objective can point to or be associated with multiple control activities. Each compliance result can point to or be associated with multiple control activities. Each control activity can point to or be associated with multiple compliance results. Each control activity can point to or be associated with multiple applicability data elements and each applicability data element can point to or be associated with multiple control activities. Each applicability data element can point to or be associated with multiple managed entities and each managed entity can point to or be associated with multiple applicability data elements.

Suppose for example, a datacenter includes computers (managed entities) that house patient health information. The computers that house patient health information might be subject to HIPAA regulations published in a HIPAA authority document. The organization that uses the datacenter computers may have created a HIPAA compliance program. The scope of the compliance program may be some subset of the datacenter computers. For example, suppose that of 10 computers, only 8 will be checked for compliance. The scope of the compliance in this case is the 8 computers that will be checked for compliance. One of the control objectives derived from the authority document for the compliance program may be “secure all servers housing health-relevant information by network authentication”. The control activity associated with that control object for a computer running Windows 7 Server software may be that a particular registry setting is set to X (e.g. control activity Y). The control activity associated with that control object for a computer running Windows Server® 2008 software may be to enable a particular function (e.g. control activity Z). Control activity Y would apply to Windows 7 computers (checking that the particular registry setting is X) hence the applicability of control activity Y would be to managed entities that are Windows 7 computers subject to the HIPAA compliance program. Similarly, control activity Z would apply to Windows Server® 2008 managed entities subject to the HIPAA compliance program. The compliance result field can hold a value indicating compliance or non-compliance, determined by checking a computer subject to the HIPAA compliance program to see if the registry setting was X (for a Windows 7 computer) or if the function was enabled (for a Windows Server® 2008 computer).

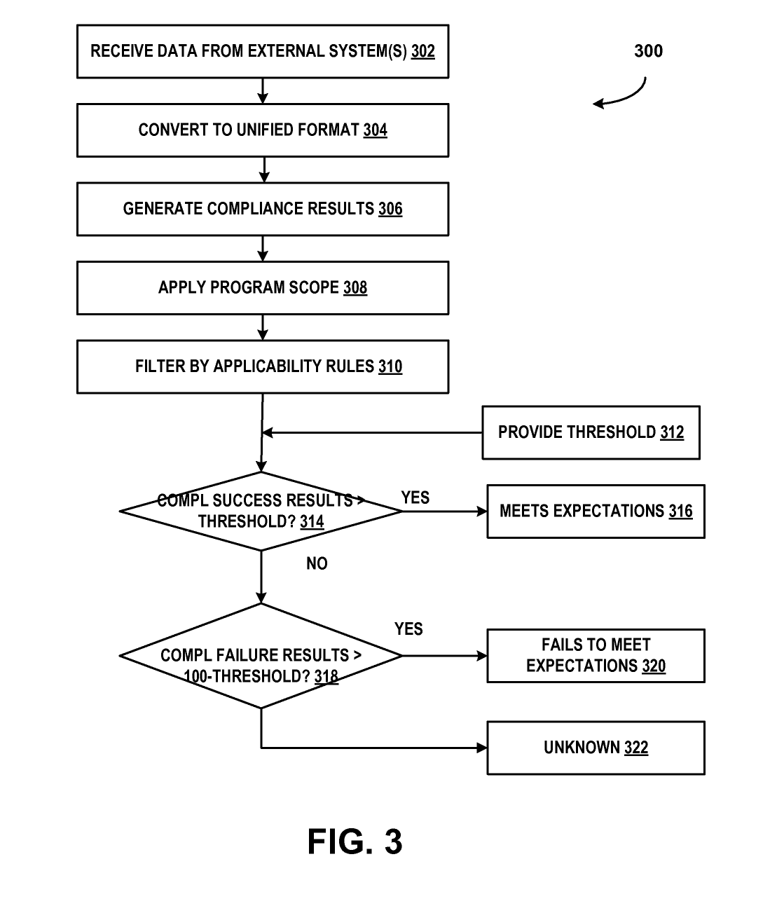

FIG. 3 is an example of a method 300 for compliance management in accordance with aspects of the subject matter disclosed herein. Method 300 can be implemented on a compliance management system such as but not limited to the one described with respect to FIG. 1. Some of the actions described below can be optional. Some of the actions described below can be executed in a sequence that differs from that described below.

At 302 a compliance management system executing on a computer such as the one described below with respect to FIG. 4 can communicate with an external system to retrieve or receive information associated with compliance from the external system(s). The information received at 302 can be converted to a unified format at 304, for example, into a format that is compatible with the schema described with respect to FIG. 2. At 306 compliance results can be generated as described above. For example, a compliance program can be created, one or more applicable directives derived from one or more authority documents associated with the compliance program can be extracted to generate one more control objectives for the program. The control objectives can be implemented via one or more control activities as described above. Control activities that are particular for a technology or operating system can be associated with managed entities running that particular technology or operating system via the applicability data element. Determining compliance state of the managed entity with the control objective can be performed by communicating with the external system to determine characteristics or settings of the external system.

Compliance results can be computed for one or more managed entities and stored in a table or relational database (e.g., compliance result 210). The compliance management system might connect to the external system to retrieve compliance information or to refresh existing compliance information. At 308 a program scope can be applied to the data, using the scope information stored in the scope table, (e.g., scope 204) for the compliance program. At 310 scoped compliance results can be generated. The results can be filtered by applicability rules. That is, information can be aggregated for a plurality of managed entities subject to the compliance program to generate compliance results for a program for an organization that includes the plurality of managed entities. At 312 a threshold can be provided to the compliance management system. The threshold provided to the compliance management system can be expressed as a percentage. At 314 the number of compliant compliance results can be compared to the provided threshold. In response to determining that the threshold is reached, a result indicating that the organization is complaint can be returned at 316. In response to determining that the threshold is not met, at 318, the number of non-compliant results can be compared to a number resulting from the subtraction of the provided threshold expressed as a percentage from 100%. If the number of non-compliant result is greater than the number resulting from the subtraction operation, a result indicating the organization is not compliant can be returned at 320.

If the number of non-compliant result is not greater than the number resulting from the subtraction operation a result indicating that compliance is unknown can be returned at 322.

### Example of a Suitable Computing Environment

In order to provide context for various aspects of the subject matter disclosed herein, FIG. 4 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 4, a computing device in the form of a computer 512 is described. Computer 512 may include a processing unit 514, a system memory 516, and a system bus 518. The processing unit 514 can be any of various available processors. Dual microprocessors and other multiprocessor architectures also can be employed as the processing unit 514. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures.

Computer 512 typically includes a variety of computer readable media such as volatile and nonvolatile media, removable and non-removable media. Computer storage media may be implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other transitory or non-transitory medium which can be used to store the desired information and which can be accessed by computer 512.

It will be appreciated that FIG. 4 describes software that can act as an intermediary between users and computer resources. This software may include an operating system 528 which can be stored on disk storage 524, and which can control and allocate resources of the computer system 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 4. Remote computer(s) 544 can be logically connected via communication connection 550. Network interface 548 encompasses communication networks such as local area networks (LANs) and wide area networks (WANs) but may also include other networks. Communication connection(s) 550 refers to the hardware/software employed to connect the network interface 548 to the bus 518. Connection 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-particular programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

While the subject matter disclosed herein has been described in connection with the figures, it is to be understood that modifications may be made to perform the same functions in different ways.

What is claimed:

1. A system comprising:
a processor and a memory of a computing device; and
at least one module on the computing device configured to cause the processor to automate compliance management of at least one managed entity by:
receiving from at least one external system, compliance-relevant data for the at least one managed entity subject to a compliance program;
generating a data structure in a unified format compatible with a compliance management schema;
extracting at least one applicable directive derived from at least one authority document associated with the compliance program;
deriving at least one control objective from the at least one applicable directive;
associating at least one control activity with the at least one control objective, the at least one control activity comprising an information technology task particular to the at least one managed entity;
determining a state of compliance of the at least one managed entity to the compliance program; and
reporting the state of compliance of the at least one managed entity.

2. The system of claim 1, wherein the at least one managed entity is one of a computer, an object, a group of people, a product, or a device.

3. The system of claim 1, wherein the at least one authority document comprises a law, a regulation, a contract, a strategy, a best practice or a policy.

4. The system of claim 1, wherein the at least one control activity comprises product configuration settings and events particular to a particular technology or platform of the at least one managed entity.

5. The system of claim 1, wherein a scope of a compliance program specifies a plurality of managed entities subject to the compliance program.

6. The system of claim 1, wherein an applicability specifies a plurality of managed entities subject to the at least one control activity.

7. The system of claim 1, wherein a compliance score displayed on a report is based on a unified data structure format for compliance.

8. A method comprising:
receiving compliance-relevant data associated with at least one managed entity subject to a compliance program from at least one external system;
transforming by a processor of a computing device, the compliance-relevant data into a standardized format compatible with a compliance management schema;
extracting at least one applicable directive derived from at least one authority document associated with the compliance program;
deriving at least one control objective from the at least one applicable directive;
associating at least one control activity with the at least one control objective, the at least one control activity comprising an information technology task particular to the at least one managed entity;
determining a compliance state of the at least one managed entity to the compliance program.

9. The method of claim 8, further comprising:
wherein a scope data element of the compliance management schema associates a group of managed entities with a compliance program.

10. The method of claim 8, further comprising:
aggregating compliance result data for a plurality of managed entities subject to the compliance program to determine compliance of a group of managed entities to the compliance program.

11. The method of claim 8, further comprising:
generating compliance report data dynamically by connecting to at least one external system to refresh compliance-relevant data for the at least one managed entity.

12. The method of claim 8, further comprising:
applying applicable control activities to the at least one managed entity and computing a compliance result for the at least one managed entity.

13. The method of claim 8, further comprising:
computing a compliance score by:
determining a number of compliant results for a plurality of managed entities subject to the compliance program,
comparing the number of compliant results for the plurality of managed entities to a received threshold:
in response to determining that the number of compliant results reaches the threshold, returning a result indicating compliance of an organization with the compliance program.

14. The method of claim 8, further comprising:
computing a compliance score by:
determining a number of non-compliant results for a plurality of managed entities subject to the compliance program,
comparing the number of non-compliant results for the plurality of managed entities to a result computed by subtracting a received threshold expressed as a percentage from 100 percent:
in response to determining that the number of non-compliant results is greater than the result, returning a result indicating non-compliance of the plurality of managed entities with the compliance program.

15. A computer-readable storage medium comprising computer-executable instructions which when executed cause at least one processor to:
convert compliance-relevant data from an external system comprising a managed entity into a unified format compatible with a compliance management schema comprising scope, compliance program, authority document, managed entity, compliance result, applicability, control activity and control objective data elements;
extract at least one applicable directive derived from at least one authority document for a compliance program to which the managed entity is subject;
derive at least one control objective from the at least one applicable directive;
associate at least one control activity with the at least one control objective, the at least one control activity comprising an information technology task particular to the managed entity subject to the compliance program;
determine a state of compliance of the managed entity to the compliance program.

16. The computer-readable storage medium of claim 15, comprising further computer-executable instructions, which when executed cause the at least one processor to:
compute a compliance score by:
determining a number of non-compliant results for managed entities subject to the compliance program,
comparing the number of non-compliant results for the managed entities to a result computed by subtracting a received threshold expressed as a percentage from 100 percent:
in response to determining that the number of non-compliant results is greater than the result, returning a result indicating non-compliance of the managed entities with the compliance program.

17. The computer-readable storage medium of claim 15, comprising further computer-executable instructions, which when executed cause the at least one processor to:
compute a compliance score by:
determining a number of non-compliant results for managed entities subject to the compliance program,
comparing the number of non-compliant results for the managed entities to a result computed by subtracting a received threshold expressed as a percentage from 100 percent:
in response to determining that the number of non-compliant results is greater than the result, returning a result indicating non-compliance of the managed entities with the compliance program.

18. The computer-readable storage medium of claim 15, comprising further computer-executable instructions, which when executed cause the at least one processor to:
aggregate compliance-relevant data from a plurality of managed entities subject to the compliance program to determine compliance of a group of managed entities to the compliance program.

19. The computer-readable storage medium of claim 15, comprising further computer-executable instructions, which when executed cause the at least one processor to:
apply applicable control activities to the managed entity and compute a compliance result for the managed entity.

20. The computer-readable storage medium of claim 15, comprising further computer-executable instructions, which when executed cause the at least one processor to:
generate compliance report data dynamically by connecting to at least one external system to refresh compliance-relevant data information.
